(19) United States
(12) Patent Application Publication
(10) Pub. No.: US 2018/0019837 A1
(43) Pub. Date: Jan. 18, 2018

(54) METHOD FOR DETERMINING COMMUNICATION METHOD, INFORMATION PROCESSING APPARATUS, AND RECORDING MEDIUM

(71) Applicant: FUJITSU LIMITED, Kawasaki-shi (JP)

(72) Inventors: Yuto Tamura, Kawasaki (JP); Kohta Nakashima, Kawasaki (JP)

(73) Assignee: FUJITSU LIMITED, Kawasaki-shi (JP)

(21) Appl. No.: 15/610,788

(22) Filed: Jun. 1, 2017

(30) Foreign Application Priority Data
Jul. 12, 2016 (JP) 2016-137587

(51) Int. Cl. H04L 1/00

(52) U.S. Cl. CPC H04L 1/0019; H04L 1/0009; H04L 1/0003; H04L 1/0007

(57) ABSTRACT

A method for determining a communication method executed by a processor included in a computer, the method includes selecting a communication method from a plurality of communication methods based on a size of communication data, by referring to selection probability information in which a range of a size of communication data and a probability of selecting a communication method are associated for each of the plurality of communication methods; executing communication using the selected communication method; updating the selection probability information based on a result of the executed communication; and executing communication based on the updated selection probability information.

### CROSS-REFERENCE TO RELATED APPLICATION

This application is based upon and claims the benefit of priority of the prior Japanese Patent Application No. 2016-137587, filed on Jul. 12, 2016, the entire contents of which are incorporated herein by reference.

### FIELD

The embodiments discussed herein are related to a method for determining a communication method, an information processing apparatus, and a recording medium.

### BACKGROUND

Systems in which a plurality of apparatuses communicate with each other through a network have been recently used. In such systems, a plurality of communication methods may be usable.

For example, a base station that selects one transmission scheme from among a plurality of transmission schemes and transmits a data signal to a terminal station is proposed. In this proposal, the base station calculates a transmission speed for each transmission scheme and selects a transmission scheme that corresponds to a maximum transmission speed, based on overhead including transmission and reception of a control signal, a data length of a data signal, a modulation scheme, a coding rate, and the number of subcarriers for transmission.

Further, a base station that determines a traffic condition for determining which of an orthogonal multiplexing scheme and a non-orthogonal multiplexing scheme is used for packet transmission by a terminal is proposed. In this proposal, the base station determines the traffic condition, based on the number of radio resource allocation signals for notifying a radio resource that is used for the orthogonal multiplexing scheme, and on an amount of interference to a terminal within a cell of the base station in the non-orthogonal multiplexing scheme.

However, the modulation scheme, the coding rate, and the indexes such as the number of radio resource allocation signals and the amount of interference in the wireless communication systems described above are not necessarily usable for selection of a communication method in any system. As related art, for example, Japanese Laid-open Patent Publication No. 2015-149556 and International Publication Pamphlet No. WO2015/015543 are disclosed.

Among a plurality of communication methods, there may be a difference in communication performance (for example, in response time or the like) depending on a size of the communication data. In this case, a communication method that increases the communication performance for the communication data that is a transmission target, compared with other communication methods, may be selected by an information processing apparatus. In order to perform such selection, for example, the communication performance in accordance with the size of the communication data may be measured in advance for each communication method, and information in which a communication method to be selected for each size (or a size range) of the communication data is determined may be stored in advance in the information processing apparatus.

However, if a communication method is determined with such a static condition, determination of the communication method is fixed by the condition. Accordingly, it may be difficult to deal with a change in the status (for example, a change in the communication performance due to a change in the load on the information processing apparatus or the like). In view of the above, it is desirable that a suitable communication method is determined in response to the change in the status.

### SUMMARY

According to an aspect of the invention, a method for determining a communication method executed by a processor included in a computer, the method includes selecting a communication method from a plurality of communication methods based on a size of communication data, by referring to selection probability information in which a range of a size of communication data and a probability of selecting a communication method are associated for each of the plurality of communication methods; executing communication using the selected communication method; updating the selection probability information based on a result of the executed communication; and executing communication based on the updated selection probability information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing apparatus according to a first embodiment;

FIG. 2 is a diagram illustrating an information processing system according to a second embodiment;

FIG. 3 is a diagram illustrating exemplary hardware of a node;

FIG. 4 is a diagram illustrating exemplary software of the node;

FIG. 5 is a diagram illustrating an exemplary function of an iSER module;

FIGS. 6A and 6B are diagrams illustrating an exemplary determination of communication method by threshold control;

FIG. 7 is a diagram illustrating an exemplary function of an iSER initiator/target;

FIG. 8 is a diagram illustrating an exemplary selection probability table;

FIG. 9 is a diagram illustrating an exemplary average response time table;

FIG. 10 is a diagram illustrating an exemplary processing invocation relationship;

FIG. 11 is a flowchart illustrating exemplary iSER initiator processing;

FIG. 12 is a flowchart illustrating exemplary iSER target processing;

FIG. 13 is a diagram illustrating a specific example (first) of selection probability update;

FIGS. 14A, 14B, and 14C are diagrams illustrating a specific example (second) of a selection probability update; and

FIGS. 15A and 15B are diagrams illustrating an exemplary table for a communication packet size.

### DESCRIPTION OF EMBODIMENTS

Embodiments are described below by referring to the drawings.

### First Embodiment

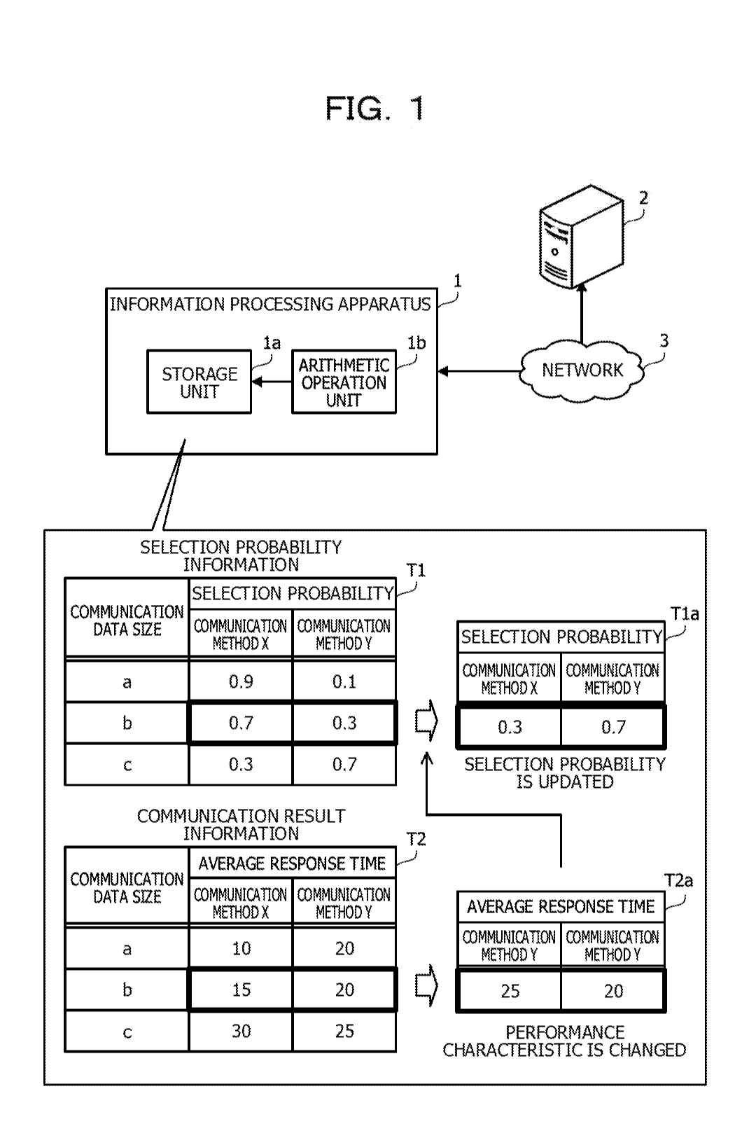

FIG. 1 is a diagram illustrating an information processing apparatus according to a first embodiment. An information processing apparatus 1 communicates with an information processing apparatus 2. The information processing apparatuses 1 and 2 are connected to a network 3 and communicate with each other through the network 3. The information processing apparatus 1 may select any one of a plurality of communication methods as a communication method that is used for the communication with the information processing apparatus 2.

The plurality of communication methods include communication methods X and Y. In a case where comparatively small-sized data is transmitted, the communication may be speeded up in the communication method X than in the communication method Y. In a case where comparatively large-sized data is transmitted, the communication may be speeded up in the communication method Y than in the communication method X.

The information processing apparatus 1 includes a storage unit 1a and an arithmetic operation unit 1b. The storage unit 1a, for example, is a volatile memory device such as a random access memory (RAM), or is a nonvolatile memory device such as a hard disk drive (HDD) or a flash memory. The arithmetic operation units 1b may include a central processing unit (CPU), a digital signal processor (DSP), an application specific integrated circuit (ASIC), a field programmable gate array (FPGA), and the like. The arithmetic operation unit 1b may be a processor that executes a program. The “processor” here may also include a group of a plurality of processors (multiprocessor).

Selection probability information T1 and communication result information T2 are stored in the storage unit 1a. The selection probability information T1 is information indicating a selection probability of a communication method that depends on a size of communication data (a communication data size).

The “communication data size” is, for example, a size of data that is currently transmitted by the information processing apparatus 1 (more specifically, data that is stored in a transmission buffer secured in the storage unit 1a). The “communication data size” may be a size of a communication packet (a communication packet size) that is lately used by the information processing apparatus 1 for data transmission.

The “selection probability” expresses a probability for causing the arithmetic operation unit 1b to select the communication method. For example, it is assumed that, for a certain data size, the number of times of data transmission on a per-communication data basis is set to N (N is an integer of 2 or greater), where n1 (n1 is an integer of 1 or greater) is the number of times that the communication method X is selected, and n2 (n2 is an integer of 1 or greater) is the number of times that the communication method Y is selected. At this time, a selection probability p1 (p1 is a real number that satisfies 0<p1<1) of the communication method X for the communication data size means that the arithmetic operation unit 1b is caused to select the communication method X so that comparatively large N satisfies n1/N to p1. In the same manner, a selection probability p2 (p2 satisfies 0<p2<1) of the communication method Y for the communication data size means that the arithmetic operation unit 1b is caused to select the communication method Y so that comparatively large N satisfies n2/N to p2.

In the exemplary selection probability information T1, the communication data size is categorized into three sizes, such as communication data sizes a, b, and c. One category (for example, the communication data size a) for the communication data size may be considered to indicate one range of the communication data size. The communication data size b is a category for the communication data size that is greater than the communication data size a. The communication data size c is a category for the communication data size that is greater than the communication data size b.

In a case where the communication data size is comparatively small, the communication method X has higher communication performance than the communication method Y. Accordingly, with the selection probability information T1, the smaller the communication data size, the higher selection probability the communication method X is set to have. In the example of the selection probability information T1, for the communication data sizes a and b, the selection probability of the communication method X may be higher than the selection probability of the communication method Y.

On the other hand, in a case where the communication data size is comparatively large, the communication method Y has higher communication performance than the communication method X. Accordingly, with the selection probability information T1, the larger the communication data size, the higher selection probability the communication method Y is set to have. In the example of the selection probability information T1, for the communication data size c, the selection probability of the communication method Y may be higher than the selection probability of the communication method X.

More specifically, in the example of the selection probability information T1, for the communication data size a, the selection probability of the communication method X is 0.9 and the selection probability of the communication method Y is 0.1. For the communication data size b, the selection probability of the communication method X is 0.7 and the selection probability of the communication method Y is 0.3. For the communication data size c, the selection probability of the communication method X is 0.3 and the selection probability of the communication method Y is 0.7. The selection probability is determined so that each communication method takes a value that is greater than 0.

The communication result information T2 is information in which a result of the communication that uses each communication method for the communication data size is recorded. The result of the communication includes an index indicating the communication performance. The index indicating the communication performance, for example, is an average response time for communication. The average response time is an arithmetical mean of a plurality of response times from a certain past point in time to the present time, which relates to the communication that uses the communication data size/communication method. For example, the arithmetic operation unit 1b receives an acknowledgement (ACK) of each communication packet, or every communication packets of which the number is predetermined, from the information processing apparatus 2. The arithmetic operation unit 1b may measure a communication response time by obtaining an interval between a point in time of the transmission of the communication packet and a point in time of reception of the ACK. In the description below, units for response time and average response time are a microsecond (similar hereinafter).

At a certain point in time, in the exemplary communication result information T2, for the communication data size a, an average response time for the communication method X is 10 and an average response time for the communication method Y is 20. For the communication data size b, the average response time for the communication method X is 15 and the average response time for the communication method Y is 20. For the communication data size c, the average response time for the communication method X is 30 and the average response time for the communication method Y is 25.

When the transmission of certain communication data is started, the arithmetic operation unit 1b stores the communication data in the transmission buffer that is secured in the storage unit 1a. Then, the arithmetic operation unit 1b acquires the selection probability of each communication method for the communication data size of the communication data, referring to the selection probability information T1. For example, when the arithmetic operation unit 1b determines that the communication data size belongs to the category that is the communication data size b, the arithmetic operation unit 1b acquires a selection probability 0.7 of the communication method X and a selection probability 0.3 of the communication method Y from the selection probability information T1.

The arithmetic operation unit 1b selects the communication method that is used for the current communication, from among a plurality communication methods (the communication methods X and Y) in accordance with the selection probability for the communication data size. For example, the arithmetic operation unit 1b selects any communication method in accordance with the selection probability 0.7 of the communication method X and the selection probability 0.3 of the communication method Y. Here, the arithmetic operation unit 1b selects the communication method X.

The arithmetic operation unit 1b records a result of the communication that uses the selected communication method. For example, the arithmetic operation unit 1b records the result of the communication that uses the selected communication method X in the communication result information T2. For example, it is assumed that, at a point in time after the current transmission of the communication data is finished, the average response time for the communication method X for the category of the communication data size b is updated to 25. A record T2a illustrates a record after the update for the communication data size b from the communication result information T2.

Based on the communication result, the arithmetic operation unit 1b updates the selection probability stored in the storage unit 1a. In the example described above, before the update of the communication result information T2, for the communication data size b, the average response time for the communication method X is 15, and the average response time for the communication method Y is 20. On the other hand, after the update of the communication result information T2, for the communication data size b, the average response time for the communication method X is 25, and the average response time for the communication method Y is 20. That is, for the communication data size b, the relationship between the communication methods X and Y in terms of duration of the average response times is reversed and a communication performance characteristic is changed.

When it is detected that the relationship between the communication methods X and Y in terms of duration of the average response times is reversed, the arithmetic operation unit 1b updates the selection probability of the communication method X and the selection probability of the communicate Y that correspond to the communication data size b registered in the selection probability information T1. Specifically, for the communication data size b, the arithmetic operation unit 1b decreases the selection probability of the communication method X, and increases the selection probability of the communication method Y. The reason is because the reversal of the relationship between the communication methods X and Y in terms of duration of the average response times described above may be understood as suggesting that in the communication for the communication data size b, there is a likelihood that the selection of the communication method Y rather than the communication method X may reduce the average response time.

The arithmetic operation unit 1b may increase or decrease the selection probability using various methods. However, as described above, the arithmetic operation unit 1b sets the selection probability of each communication method to be higher than 0. This is for comparing the response times for the communication methods also after the update of the selection probabilities.

For example, the arithmetic operation unit 1b causes the relationship between the selection probabilities in terms of frequency to be reversed according to the reversal of the relationship between the average response times in terms of duration. In the example described above, for the communication data size b, the arithmetic operation unit 1b updates the selection probability of the communication method X with 0.3 and updates the selection probability of the communication method Y with 0.7. A record Tia illustrates a record after the update for the communication data size b in the selection probability information T1.

Alternatively, the arithmetic operation unit 1b may gradually perform the update of the selection probability by a certain amount of change at a time determined with a predetermined periodicity. For example, the arithmetic operation unit 1b gradually decreases the selection probability of the communication method X by 0.1 at a time from 0.7 to 0.3. On the other hand, the arithmetic operation unit 1b gradually increases the selection probability of the communication method Y by 0.1 at a time from 0.3 to 0.7. While the gradual increase or decrease is performed, when it is detected that the relationship between the communication methods X and Y in terms of duration of the average response times for the communication data size b is again reversed, the arithmetic operation unit 1b returns the selection probability of the communication method X to 0.7 and the selection probability of the communication method Y to 0.3. This is because the initial reversal of the relationship between the communication methods X and Y in terms of duration of the average response times has occurred highly likely due to some temporary factors.

For example, it is considered that the communication performance according to the communication data size is measured in advance for each communication method, at the time of development of an apparatus, or the like, and that a condition under which the communication method to be selected for each communication data size is determined is stored in advance in the information processing apparatus.

However, when the communication method is determined with such static condition, the determination of the communication method is fixed by the condition. Accordingly, there is a problem in that a change in a status (for example, a change in the communication performance due to a change in the load on the information processing apparatus or the like) may be difficult to deal with.

On the other hand, with the information processing apparatus 1, the communication method is selected in accordance with the selection probability, and the selection probability is updated based on the result of the communication. At this time, for a certain communication data size, the selection probability of the communication method that may realize relatively high communication performance is set to be relatively high, and the selection probability of the communication method with which the communication performance is relative low is set to be relatively low. Accordingly, it is possible that, while comparatively high communication performance is realized, a change in the performance characteristic is grasped with comparison between the communication performances of the communication methods. Thus, the information processing apparatus 1 may determine the communication method suitable for the change in the status.

### Second Embodiment

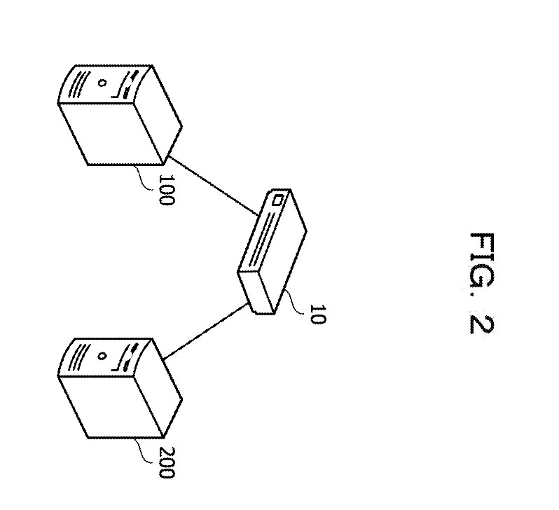

FIG. 2 is a diagram illustrating an information processing system according to a second embodiment. The information processing system according to the second embodiment includes nodes 100 and 200. The nodes 100 and 200 are connected to an InfiniBand (InfiniBand is a registered trademark in the United States) switch 10 through an InfiniBand (IB) cable. A network that is formed using the InfiniBand switch 10 is an example of the network 3 according to the first embodiment.

The nodes 100 and 200 communicate with each other through the InfiniBand switch 10. For example, the nodes 100 and 200 perform remote direct memory access (RDMA) using iSCSI extensions for RDMA (iSER). iSCSI is an abbreviation for an Internet Small Computer System Interface. The nodes 100 and 200 may be referred to as computers, servers, or the like. The node 100 is an example of the information processing apparatus 1 according to the first embodiment.

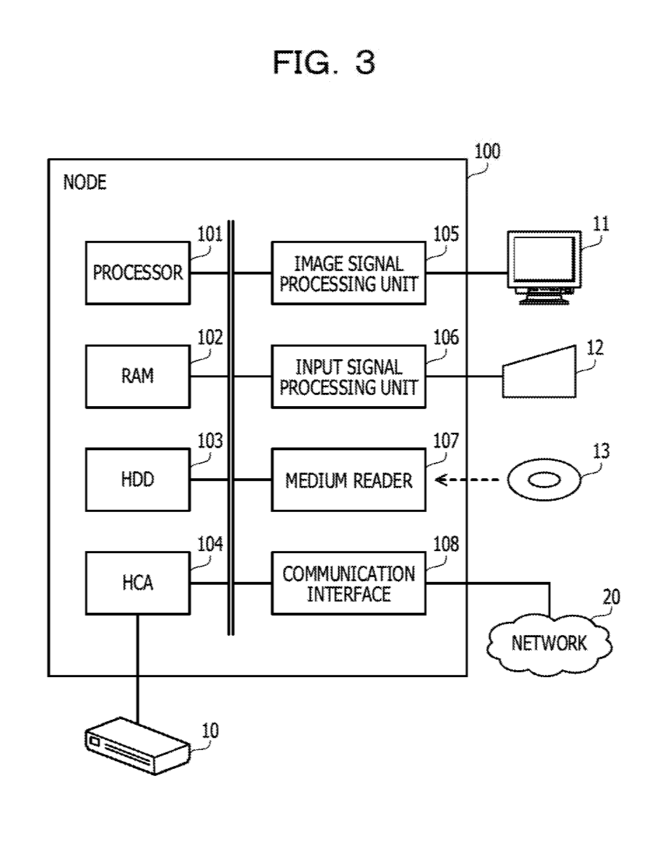

FIG. 3 is a diagram illustrating exemplary hardware of a node. The node 100 includes a processor 101, a RAM 102, a HDD 103, a host channel adapter (HCA) 104, an image signal processing unit 105, an input signal processing unit 106, a medium reader 107, and a communication interface 108. Each unit is connected to a bus of the node 100. The node 200 may also be realized using the same units as those of the node 100.

The processor 101 controls information processing by the node 100. The processor 101 may be a multiprocessor. The processor 101, for example, is a CPU, a DSP, an ASIC, a FPGA, or the like. The processor 101 may be a combination of two or more elements among the CPU, the DSP, the ASIC, the FPGA, and the like.

The RAM 102 is a main storage device of the node 100. At least a part of a program of an operating system (OS) and an application program executed by the processor 101 is temporarily stored in the RAM 102. Various data used for the processing by the processor 101 are stored in the RAM 102.

The HDD 103 is an auxiliary storage device of the node 100. In the HDD 103, writing and reading are magnetically performed on a built-in magnetic disk. The program of the OS, the application program, and various data are stored in the HDD 103. The node 100 may include another type of auxiliary storage devices, such as a flash memory or a solid state drive (SSD). The node 100 may include a plurality of auxiliary storage devices.

The HCA 104 is connected to the InfiniBand switch 10 by using the IB cable. The HCA 104 communicates with the node 200 through the InfiniBand switch 10.

In accordance with a command from the processor 101, the image signal processing unit 105 outputs an image to a display 11 connected to the node 100. As the display 11, a cathode ray tube (CRT) display, a liquid crystal display, or the like may be used.

The input signal processing unit 106 acquires an input signal from an input device 12 connected to the node 100, and outputs the acquired input signal to the processor 101. The input display 12 is, for example, a pointing device such as a mouse or a touch panel, a keyboard, or the like.

The medium reader 107 is a device that reads a program or data recorded in a recording medium 13. Examples of the recording medium 13 include, for example, a magnetic disk such as a flexible disk (FD) or a HDD, an optical disk such as a compact disk (CD) or a digital versatile disk (DVD), and a magneto-optical (MO) disk. The recording medium 13 is, for example, a nonvolatile semiconductor memory such as a flash memory card. In accordance with the command from, for example, the processor 101, the medium reader 107 stores a program or data read from the recording medium 13 in the RAM 102 or the HDD 103.

The communication interface 108 is connected to the network 20. The communication interface 108 performs communication with another information processing apparatus through the network 20.

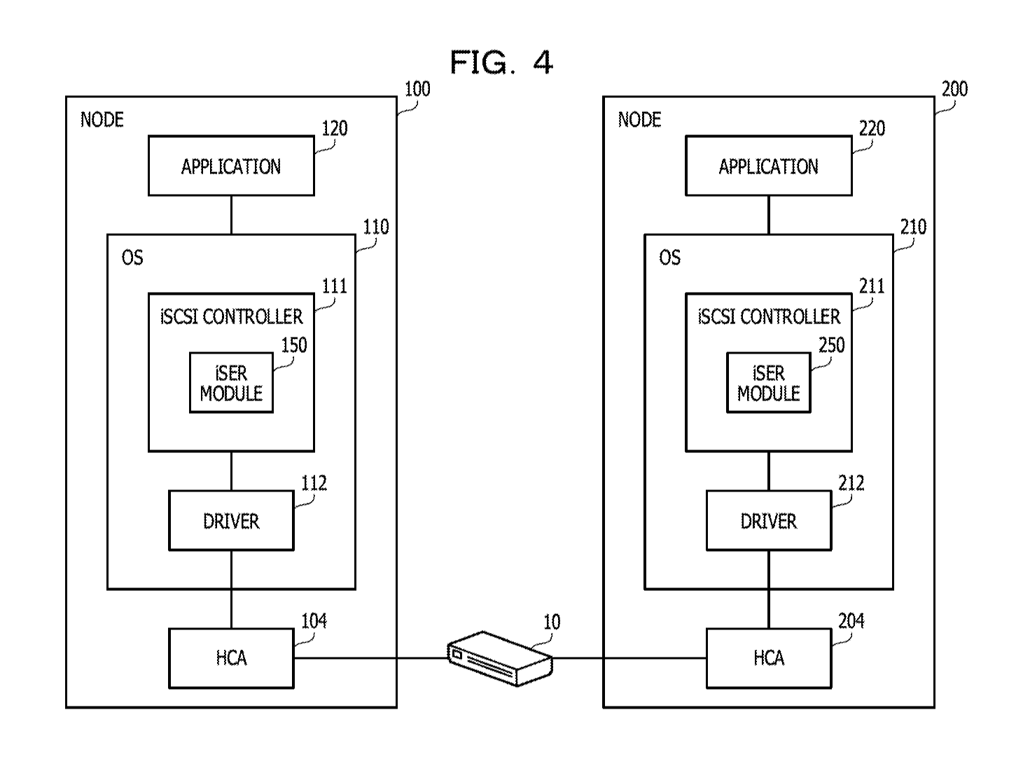

FIG. 4 is a diagram illustrating exemplary software of a node. The node 100 includes an OS 110 and an application 120. The OS 110 is basic software that controls the entire node 100. The application 120 is software that, in the node 100, provides a function of supporting a user's job.

The OS 110 includes an iSCSI controller 111 and a driver 112. The iSCSI controller 111 is a software module that processes an iSCSI protocol. The iSCSI controller 111 includes an iSER module 150. The iSER module 150 is a module that provides an RDMA function. The driver 112 is software that controls the HCA 104.

Like the node 100, the node 200 includes an OS 210 and an application 220. The OS 210 is basic software that controls the entire node 200. The application 220 is software that, in the node 200, provides the function of supporting the user's job.

The OS 210 includes an iSCSI controller 211 and a driver 212. The iSCSI controller 211 is the software module that processes the iSCSI protocol. The iSCSI controller 211 includes an iSER module 250. The iSER module 250 is the module that provides the RDMA function. The driver 212 is software that controls a HCA 204.

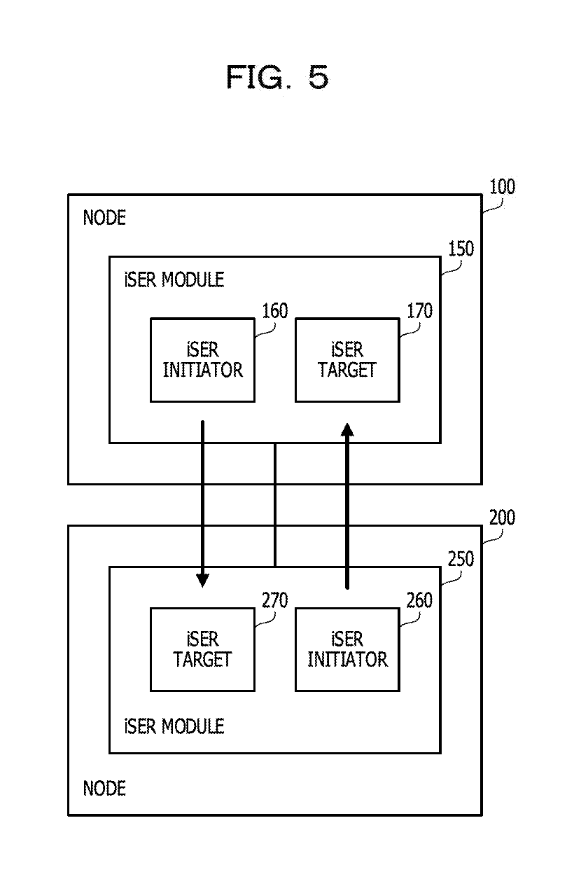

FIG. 5 is a diagram illustrating an exemplary function of an iSER module. The iSER module 150 has functions of an iSER initiator 160 and an iSER target 170. The iSER module 250 has functions of an iSER initiator 260 and an iSER target 270.

An iSER initiator 160 is connected to an iSER target 270 for communication. Similarly, an iSER initiator 260 is connected to an iSER target 170 for communication. At the time of the communication, the node that functions as the iSER initiator is also referred to as a client node. The node that functions as the iSER target is also referred to as a server node. That is, the node 100 may operate as the client node, and the node 200 may operate as the server node. The node 200 may operate as the client node, and the node 100 may operate as the server node.

Two types of communication methods (which are assumed to be the communication methods A and B) may be selected for the data transmission through the RDMA using the iSER. The communication method A is RDMA_SEND (may be simply referred to as SEND). The communication method B is RDMA_WRITE (may be simply referred to as RDMA). The RDMA_WRITE is also referred to as zero copy communication.

In RDMA_WRITE, in order to secure a memory area in the RAM 102, which is an object for transmission, while the communication is in progress (for example, in order to avoid swap-out of the memory area), memory registration processing is performed. On the other hand, this memory registration processing is not performed in SEND, instead, processing for copying communication data in the RAM 102 to a predetermined buffer for communication in the RAM 102 is performed by the processor 101. In this manner, in SEND and RDMA_WRITE, different processing is performed. There is the following relationship between the communication data size and a communication response time for each processing operation.

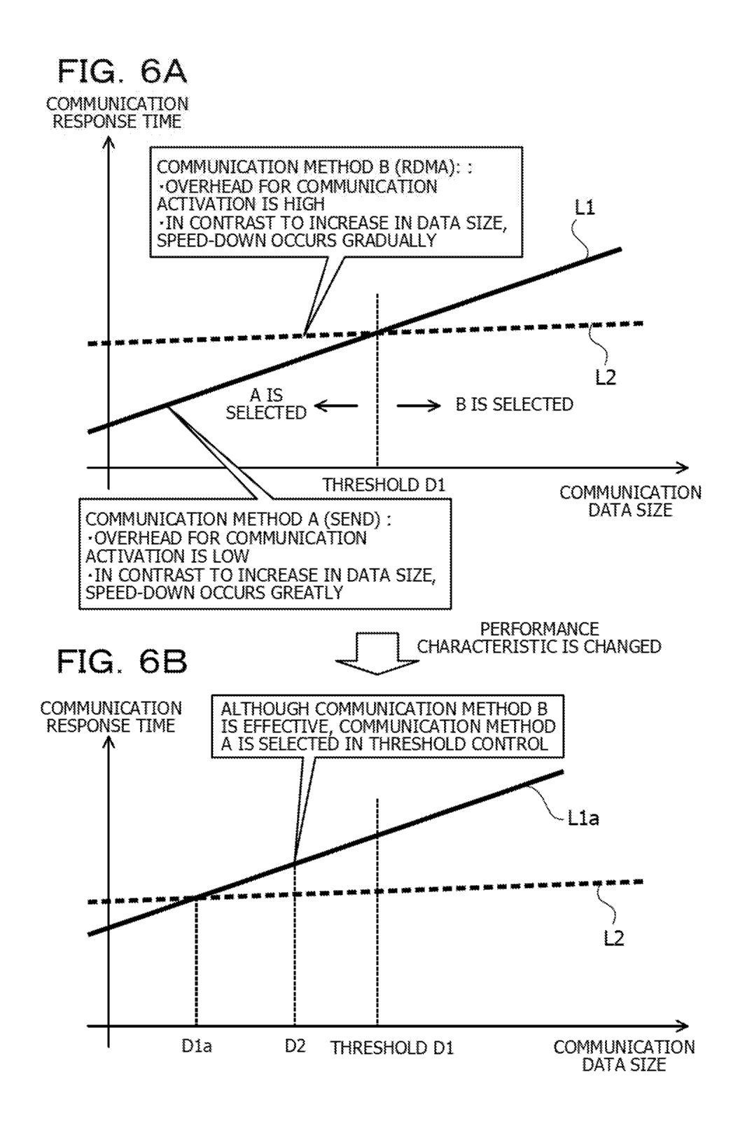

FIGS. 6A and 6B are diagrams illustrating an exemplary determination of communication method by threshold control. In FIGS. 6A and 6B, the communication data size is plotted along the horizontal axis, and the communication response time is plotted along the vertical axis. A direction from the left side of the horizontal axis to the right side thereof is a positive direction. A direction from the lower side of the vertical axis to the upper side thereof is a positive direction.

FIG. 6A illustrates an exemplary relationship between the communication data size and the communication response time. A solid straight line L1 indicates a case where the communication method A (SEND) is used. A dotted straight line L2 indicates a case where the communication method B (RDMA) is used.

Overhead for communication activation is lower in the communication method A than in the communication method B. On the other hand, the speed-down of the communication response time in response to an increase in the communication data size occurs more greatly in the communication method A than in the communication method B.

The overhead for the communication activation is higher in the communication method B than in the communication method A. On the other hand, the speed-down of the communication response time in response to the increase in the communication data size occurs more gradually in the communication method B than in the communication method A.

When such relationship is recognized, it is considered that the threshold control according to a static condition is performed as a method for selecting the communication method. Specifically, the relationship described above between the communication methods A and B is examined in advance, and the communication data size for which the relationship between the communication response times in terms of duration is reversed as indicated by the straight lines L1 and L2 is set as a threshold D1 for the node. The node selects any one of the communication methods A and B by comparison between the communication data size that is actually transmitted and the threshold D1. For example, if the communication data size is smaller than the threshold D1, the node selects the communication method A. If the communication data size is equal to or greater than the threshold D1, the communication method B is selected.

However, the relationship illustrated in FIG. 6A does not always hold. For example, in an actual environment, the relationship between the communication data size and the communication response time may change in response to a change in a status such as the load in accordance with operation of the node. FIG. 6B illustrates the relationship (which is equivalent to a solid straight line L1a) between the communication data size and the communication response time for the communication method A after the change. The straight line L1a is shifted more to the left side than the straight line L1. Accordingly, the communication data size D1a for which the relationship between the communication response times in terms of duration is reversed as indicated by the straight lines L1a and L2 is smaller than the threshold Dl.

In this case, if the threshold control that uses the threshold value D1 is performed, when the communication data size is equal to or greater than a communication data size D1a, and is a value D2 that is smaller than the threshold D1, the node selects the communication method A although the communication method B is actually effective. In this manner, with the threshold control under the static condition, it is difficult to select a suitable communication method in accordance with the change in the status.

Accordingly, the nodes 100 and 200 provide a function of enabling the suitable communication method to be selectable in accordance with the change in the status. In the following, an example in which the node 100 functions as the iSER initiator 160 and the node 200 functions as the iSER target 270 is illustrated, but the nodes 100 and 200 may play roles of the iSER initiator and target in a reversed manner, respectively.

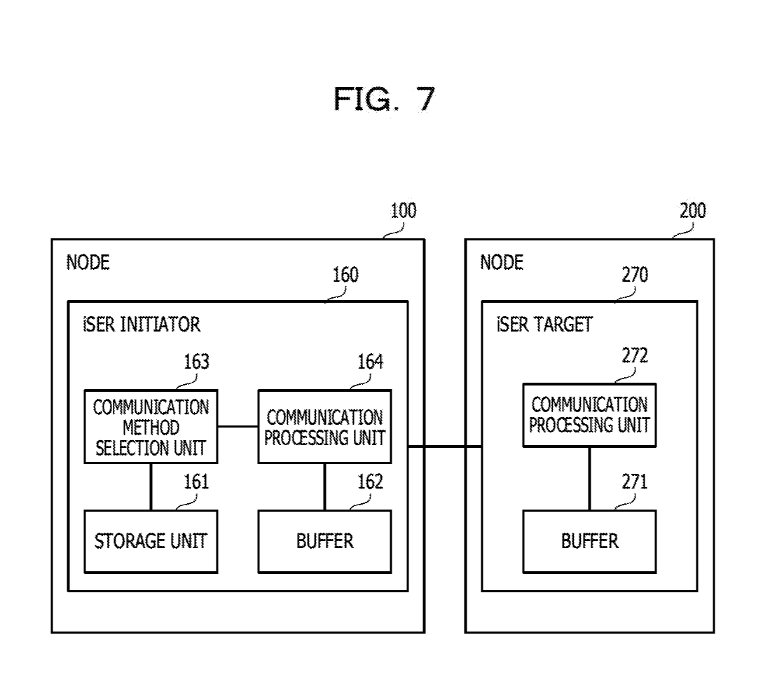

FIG. 7 is a diagram illustrating an exemplary function of the iSER initiator/target. The iSER initiator 160 includes a storage unit 161, a buffer 162, a communication method selection unit 163, and a communication processing unit 164. The storage unit 161 is realized by using a storage area that is secured in the RAM 102 or the HDD 103. The buffer 162 is realized using a storage area that is secured in the RAM 102. The processor 101 executes a program stored in the RAM 102, and thus the communication method selection unit 163 and the communication processing unit 164 are realized.

A selection probability table and an average response time table are stored in the storage unit 161. The selection probability table is a table in which the selection probability of the communication method A and the selection probability of the communication method B are registered in association with a range of sizes of data that is a transmission target (referred to as to a transmission data size range). The average response time table is a table in which the average response time for the communication method A and the average response time for the communication method B are registered in association with the transmission data size range. The average response time is calculated using the arithmetical mean.

Data (referred to as transmission data) that is a transmission target is temporarily stored in the buffer 162. Transmission data that is stored in the buffer 162 is an example of the communication data (in this case, a transmission data size is also an example of the communication data size).

Based on the selection probability table stored in the storage unit 161, the communication method selection unit 163 selects the communication method that is used for current transmission of the transmission data. The communication method selection unit 163 measures the average response time for the selected communication method, and updates the average response time table stored in the storage unit 161. The communication method selection unit 163 updates the selection probability stored in the selection probability table in accordance with the update of the average response time table.

The communication processing unit 164 transmits the transmission data to the node 200, using the communication method that is selected by the communication method selection unit 163. Specifically, the communication processing unit 164 packetizes the transmission data and transmits the resulting transmission data to the node 200. If a size of the transmission data is greater than a size that fits into one InfiniBand (IB) packet, the communication processing unit 164 divides the transmission data to generate a plurality of IB packets, and transmits the resulting plurality of IB packets to the node 200. For example, the communication processing unit 164 receives an ACK of each IB packet from the node 200. Alternatively, the communication processing unit 164 may receive an ACK on a certain number of IB packets basis from the node 200.

The iSER target 270 includes a buffer 271 and a communication processing unit 272. The buffer 271 is realized by using a storage area that is secured in the RAM included in the node 200. A processor included in the node 200 executes a program stored in the RAM included in the node 200, and thus the communication processing unit 272 is realized.

Data (which is referred to as reception data) received from the node 100 is temporarily stored in the buffer 271.

The communication processing unit 272 receives the packetized reception data from the node 100. The communication processing unit 272 specifies the selected communication method from the reception data. Then, the communication processing unit 272 performs predetermined reception processing on the reception data in accordance with the specified communication method. The communication processing unit 272 transmits the ACK of each IB packet to the node 100. Alternatively, the communication processing unit 272 may transmit an ACK on a certain number of IB packets basis to the node 100.

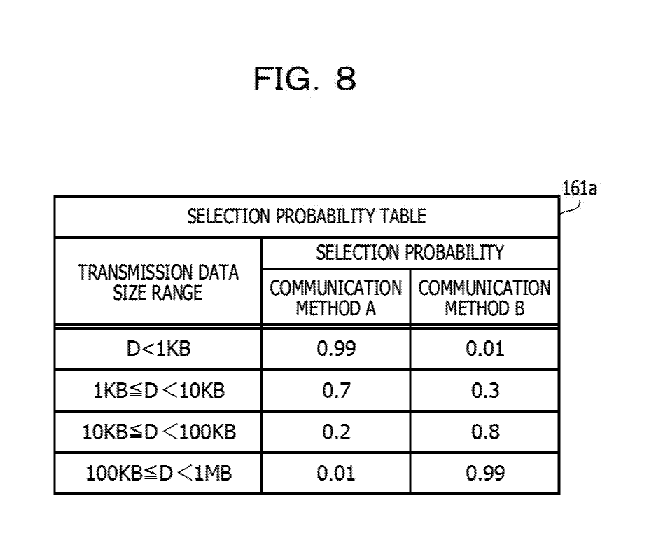

FIG. 8 is a diagram illustrating an exemplary selection probability table. A selection probability table 161a is stored in the storage unit 161. The selection probability table 161a includes items of the transmission data size range and the selection probability.

The transmission data size range is registered in the item of the transmission data size range. Here, D is a symbol indicating the transmission data size range. In an example in FIG. 8, the transmission data size ranges are categorized into four ranges, that is, D<1 KB (KB is an abbreviation for kilobyte), 1 KB≦D<10 KB, 10 KB≦D<100 KB, and 100 KB≦D<1 MB (MB is an abbreviation for megabyte). The selection probability of the communication method A and the selection probability of the communication method B are registered in the item of the selection probability.

As described in FIGS. 6A and 6B, the communication method A is advantageous in a case where the size of the transmission data is comparatively small. Accordingly, in two categories in which the transmission data size range is small, the selection probability of the communication method A is set to be higher than the selection probability of the communication method B. The communication method B is advantageous in a case where the size of the transmission data is comparatively large. Accordingly, in two categories in which the transmission data size range is large, the selection probability of the communication method B is set to be higher than the selection probability of the communication method A.

For example, information such as a transmission data size range “D<1 KB” (KB is an abbreviation for kilobyte), a selection probability “0.99” of the communication method A, and a selection probability “0.01” of the communication method B is registered in the selection probability table 161a. This indicates that, in a case where the transmission data size range is less than 1 KB, the selection probability of the communication method A is set to 0.99 (=99%) and the selection probability of the communication method B is set to 0.01 (=1%).

Similarly, in the selection probability table 161a, when the transmission data size range is 1 KB≦D<10 KB, the selection probability of the communication method A is set to 0.7, and the selection probability of the communication method B is set to 0.3. When the transmission data size range is 10 KB≦D<100 KB, the selection probability of the communication method A is set to 0.2, and the selection probability of the communication method B is set to 0.8. Furthermore, when the transmission data size range is 100 KB≦D<1 MB, the selection probability of the communication method A is set to 0.01, and the selection probability of the communication method B is set to 0.99.

The selection probability of the communication method A and the selection probability of the communication method B are determined so that each value is greater than 0.

An initial value for a setting in the selection probability table 161a illustrated in FIG. 8 may be determined with the threshold D1 that is temporarily obtained in advance in a verification environment. For example, in a case where the setting in the selection probability table 161a illustrated in FIG. 8 is considered as the initial value, threshold D1 may be 10 KB. A further larger transmission data size may be managed using the selection probability table 161a.

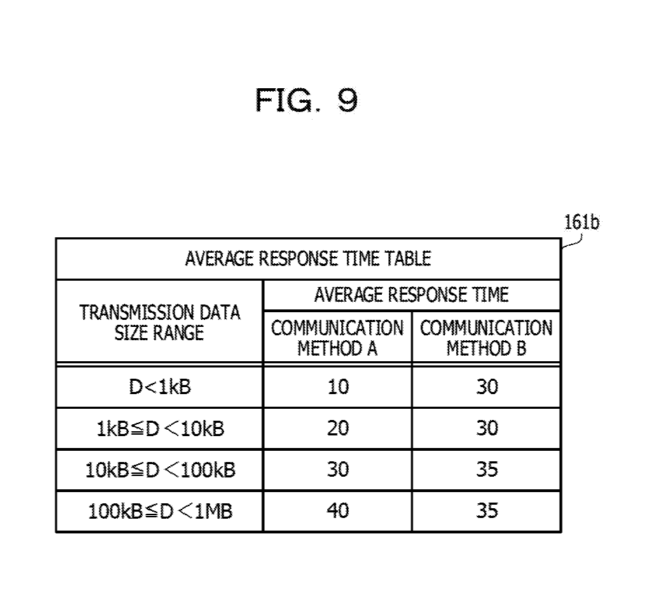

FIG. 9 is a diagram illustrating an exemplary average response time table. An average response time table 161b is stored in the storage unit 161. The average response time table 161b includes items of the transmission data size range and the average response time.

The transmission data size range is registered in the item of the transmission data size range. The average response time for the communication that uses the communication method A, and the average response time for the communication that uses the communication method B are registered in the item of the average response time. A unit for the average response time is defined as a microsecond.

For example, information such as a transmission data size range “D <1 KB”, an average response time “10” of the communication method A, and the average response time “30” of the communication method B is registered in the average response time table 161b. This indicates that, in a case where the transmission data size range is less than 1 KB, the average response time for the communication method A is 10 microseconds and the average response time for the communication method B is 30 microseconds.

Similarly, in the average response time table 161b, when the transmission data size range is 1 KB≦D<10 KB, the average response time for the communication method A is 20 microseconds and the average response time for the communication method B is 30 microseconds. When the transmission data size range is 10 KB≦D<100 KB, the average response time for the communication method A is 30 microseconds and the average response time for the communication method B is 35 microseconds. Additionally, When the transmission data size range is 100 KB≦D<1 MB, the average response time for the communication method A is 40 microseconds and the average response time for the communication method B is 35 microseconds.

However, the selection probability in the selection probability table 161a and the average response time in the average response time table 161b may be updated by the communication method selection unit 163.

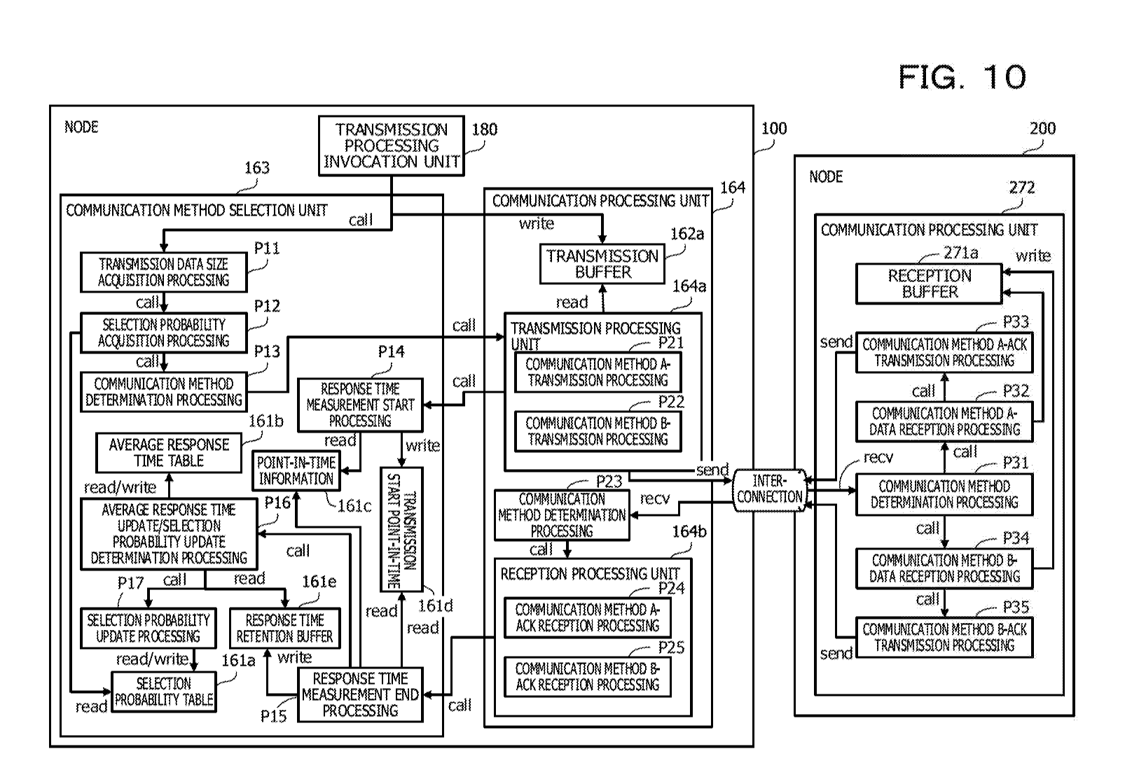

FIG. 10 is a diagram illustrating an exemplary processing invocation relationship. The communication method selection unit 163 and the communication processing unit 164 perform transmission processing of the transmission data in cooperation with each other. For example, the communication method selection unit 163 performs a transmission data size acquisition processing P11, a selection probability acquisition processing P12, a communication method determination processing P13, a response time measurement start processing P14, a response time measurement end processing P15, an average response time update/selection probability update determination processing P16, and a selection probability update processing P17, as sub-processes.

The communication processing unit 164 has a transmission processing unit 164a and a reception processing unit 164b. The transmission processing unit 164a performs the transmission processing of the transmission data, using the communication method that is selected by the communication method selection unit 163. Specifically, the transmission processing unit 164a performs communication method A-transmission processing P21 and communication method B-transmission processing P22, as sub-processes. The reception processing unit 164b performs processing that receives a reception ACK relating to the communication that uses the communication method. Specifically, the reception processing unit 164b executes communication method A-ACK reception processing P24 and communication method B-ACK reception processing P25, as sub-processes.

Additionally, the communication processing unit 272 performs communication method determination processing P31, communication method A-data reception processing P32, communication method A-ACK transmission processing P33, communication method B-data reception processing P34, and communication method B-ACK transmission processing P35, as sub-processes.

First, when the data (the transmission data) that is the transmission target occurs, a transmission processing invocation unit 180 invokes the transmission data size acquisition processing P11 by the communication method selection unit 163. The transmission processing invocation unit 180 writes the transmission data to the transmission buffer 162a. The transmission buffer 162a is a buffer area of the buffer 162, which is secured for the communication processing unit 164. The transmission processing invocation unit 180 may, for example, be one function of the OS 110.

The transmission data size acquisition processing P11 is processing that acquires a size of the transmission data. In the transmission data size acquisition processing P11, the selection probability acquisition processing P12 is invoked. The selection probability acquisition processing P12 is processing that acquires the selection probability of each communication method based on a size of the transmission data and the selection probability table 161a. In the selection probability acquisition processing P12, the communication method determination processing P13 is invoked.

The communication method determination processing P13 is processing that determines the communication method used for the current communication, in accordance with the selection probability of each communication method. In the communication method determination processing P13, transmission processing corresponding to the selected communication method in the transmission processing unit 164a is invoked. Candidates of transmission processing to be invoked are communication method A-transmission processing P21 and communication method B-transmission processing P22.

The communication method A-transmission processing P21 is processing that transmits the transmission data stored in the transmission buffer 162a by using a SEND scheme. The communication method B-transmission processing P22 is processing that transmits the transmission data stored in the transmission buffer 162a by using a RDMA_WRITE scheme. In the communication method A-transmission processing P21 and the communication method B-transmission processing P22, the response time measurement start processing P14 is invoked at the time of data transmission. In the response time measurement start processing P14, a transmission start point-in-time 161d is stored in the storage unit 161 by referring to a point-in-time information 161c. In the response time measurement start processing P14, the transmission start point-in-time 161d may be recorded in association with information (for example, a sequence number included in a transport header) for identifying the IB packet. The point-in-time information 161c may be information that is recorded in the storage unit 161 by performing a predetermined timer function, or may be information that is provided by a certain hardware timer of the node 100. The data transmitted from the node 100 reaches the node 200 through interconnection (the InfiniBand switch 10).

The communication method determination processing P31 is processing that determines the communication method based on the received data. In a case where a result of the determination is the communication method A, the communication method A-data reception processing P32 is invoked in the communication method determination processing P31. In a case where a result of the determination is the communication method B, the communication method B-data reception processing P34 is invoked in the communication method determination processing P31.

The communication method A-data reception processing P32 is processing that receives the data in accordance with the communication method A (SEND). In the communication method A-data reception processing P32, the reception data is written to a reception buffer 271a, and the communication method A-ACK transmission processing P33 is invoked. The reception buffer 271a is a buffer area of the buffer 271, which is secured for the communication processing unit 272. The communication method A-ACK transmission processing P33 is processing that transmits the ACK in accordance with the communication method A.

The communication method B-data reception processing P34 is processing that receives data in accordance with the communication method B (RDMA_WRITE). In the communication method B-data reception processing P34, the reception data is written to the reception buffer 271a, and the communication method B-ACK transmission processing P35 is invoked. The communication method B-ACK transmission processing P35 is processing that transmits the ACK in accordance with the communication method B.

The ACK transmitted by the node 200 reaches the node 100 through the interconnection. The ACK includes an ACK number. Communication method determination processing P23 is processing that receives the ACK and determines the communication method by using the received ACK. For example, in the communication method determination processing P23, a correspondence relationship between a sequence number of the IB packet of which the transmission is completed by the transmission processing unit 164a, and the communication method used for the transmission of the IB packet is stored in the storage unit 161. In the communication method determination processing P23, the sequence number of the transmission-completed IB packet and the received ACK may be associated with each other, from a relationship between a transmission packet size, an ACK number, and the sequence number of the IB packet of which the transmission is completed. Consequently, in the communication method determination processing P23, a method in which the received ACK is transmitted may be determined from details (a relationship between the sequence number of the transmission-completed IB packet and the communication method) that is recorded in the storage unit 161. In a case where a result of the determination is the communication method A, the communication method A-ACK reception processing P24 is invoked in the communication method determination processing P23. In a case where the result of the determination is the communication method B, the communication method B-ACK reception processing P25 is invoked in the communication method determination processing P23.

The communication method A-ACK reception processing P24 is processing that receives the ACK in accordance with the communication method A (SEND). The communication method B-ACK reception processing P25 is processing that receives the ACK in accordance with the communication method B (RDMA_WRITE). In the communication method A-ACK reception processing P24 and the communication method B-ACK reception processing P25, when the processing that receives the ACK is finished, the response time measurement end processing P15 is invoked. The reception processing unit 164b may notify the response time measurement end processing P15 of the sequence number of the transmission-completed IB packet, the reception of the ACK thereof is finished.

The response time measurement end processing P15 is processing that ends measurement of the response time used for the IB packet and records the measured response time in a response time retention buffer 161e. The response time retention buffer 161e is a buffer area secured in the storage unit 161. In the response time measurement end processing P15, a current point in time is acquired by referring to the point-in-time information 161c. Then, a time difference between the transmission start point-in-time 161d and the current point in time is calculated as the response time. As described above, as the transmission start point-in-time 161d, the sequence number of the transmission-completed IB packet and a transmission start point in time are recorded in association with each other, and thus a response time for the transmission-competed IB packet of which the sequence number is notified by the reception processing unit 164b is measured. The response time measurement end processing P15 invokes the average response time update/selection probability update determination processing P16.

The average response time update/selection probability update determination processing P16 is processing that updates the average response time table 161b and that determines whether or not selection probability update is performed. In the average response time update/selection probability update determination processing P16, the response time newly recorded in the response time retention buffer 161e is read, and the average response time for the transmission data size acquired in the transmission data size acquisition processing P11 is updated. In the average response time update/selection probability update determination processing P16, for calculation of the average response time, the average response time up to now is read from the average response time table 161b, and writing of the newly calculated average response time is performed. Further, in the average response time update/selection probability update determination processing P16, it is determined whether or not to perform the update of the selection probabilities of the communication methods A and B, based on the post-update average response time table 161b. Then, in a case where it is determined that the update of the selection probability is performed, the selection probability update processing P17 is invoked. On the other hand, in a case where it is determined that the update of the selection probability is not performed, data transmission processing is finished without doing anything.

The selection probability update processing P17 is processing that updates the selection probabilities of the communication methods A and B. In the selection probability update processing P17, an existing selection probability is acquired from the selection probability table 161a. Then, according to a predetermined increase and decrease method, the update for increasing or decreasing the selection probabilities of the communication methods A and B is performed. Then, a result of the update is written to the selection probability table 161a, and the data communication processing is finished.

Next, a processing procedure by the iSER initiator 160 of the node 100 is described.

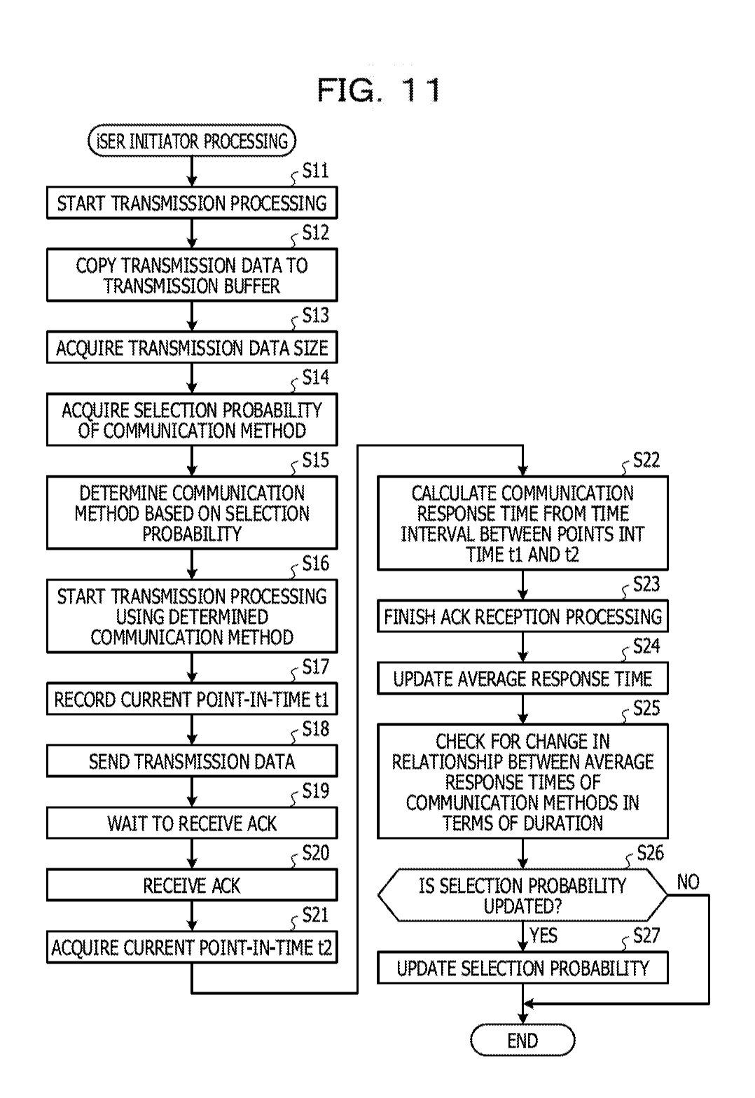

FIG. 11 is a flowchart illustrating exemplary iSER initiator processing. Processing illustrated in FIG. 11 is described according to a sequential processing number.

(S11) The transmission processing invocation unit 180 notifies the communication method selection unit 163 that the transmission processing is started.

(S12) The transmission processing invocation unit 180 copies the transmission data to the buffer 162. For example, as described above, the transmission processing invocation unit 180 stores the transmission data in the transmission buffer 162a secured within the buffer 162,.

(S13) The communication method selection unit 163 acquires the size (the transmission data size) of the transmission data stored in the buffer 162.

(S14) The communication method selection unit 163 acquires the selection probability of the communication method that corresponds to the transmission data size acquired in S13, by referring to the selection probability table 161a stored in the storage unit 161. For example, candidates for the communication method to be selected are the communication methods A and B. Accordingly, the communication method selection unit 163 acquires the selection probability of the communication method A that corresponds to the transmission data size, and the selection probability of the communication method B that corresponds to the transmission data size.

(S15) Based on the acquired selection probability of the communication method A and the acquired selection probability of the communication method B, the communication method selection unit 163 determines the communication method that is used for the current data transmission. Specifically, the number of times of the data transmission in the transmission data size is set to N, and among N, the number of times that the communication method A is selected is set to n1 and the number of times that the communication method B is selected is set to n2. The communication method selection unit 163 selects the communication method A for the transmission data size in such a manner that comparatively large N satisfies n1/N to p1. The communication method selection unit 163 selects the communication method B for the transmission data size in such a manner that comparatively large N satisfies n2/N to p2. The communication method selection unit 163 notifies the communication processing unit 164 of a result of the determination.

(S16) The communication processing unit 164 starts the transmission processing by using the communication method that is determined by the communication method selection unit 163. The communication processing unit 164 notifies the communication method selection unit 163 that the transmission processing is started.

(S17) The communication method selection unit 163 records a current point-in-time t1 in the storage unit 161. The current point-in-time t1 is equivalent to the transmission start point-in-time 161d that is described with reference to FIG. 10.

(S18) The communication processing unit 164 sends the transmission data, which is stored in the buffer 162, to the node 200.

(S19) The communication processing unit 164 waits to receive the ACK.

(S20) The communication processing unit 164 receives the ACK of the data transmitted in S18, from the node 200. The communication processing unit 164 notifies the communication method selection unit 163 that the ACK is received.

(S21) The communication method selection unit 163 acquires a current point-in-time t2.

(S22) The communication method selection unit 163 specifies the point-in-time t1 that is recorded in S17, from the ACK, and obtains a time interval between the points in time t1 and t2, and thus calculates the communication response time for the current communication. The calculated communication response time is defined as Tc.

(S23) The communication processing unit 164 finishes ACK reception processing.

(S24) The communication method selection unit 163 updates the average response time table 161b stored in the storage unit 161. Specifically, the communication method selection unit 163 acquires an average response time Ta that corresponds to the current transmission data size and communication method, from the average response time table 161b. The communication method selection unit 163 sets the number of times of selection of the communication method for the transmission data size up to now to n, and records Ta′={(n−1)Ta+Tc}/n, as a post-update average response time, in the average response time table 161b.

(S25) The communication method selection unit 163 checks for a change in the relationship between the average response times of the communication methods in terms of duration before and after the update of the average response time table 161b in S24.

(S26) The communication method selection unit 163 determines whether or not the selection probability of the communication method is updated, in response to the check for the change in S25. In a case where the selection probability of the communication method is updated, the processing proceeds to S27. In a case where the selection probability of the communication method is not updated, the processing is ended. Specifically, in a case where the relationship between the average response times of the communication method A and the communication method B in terms of duration for the transmission data size is reversed with the current update, the communication method selection unit 163 determines that the selection probability is to be updated. On the other hand, in a case where the relationship between the average response times of the communication method A and the communication method B in terms of duration for the transmission data size is not reversed with the current update, the communication method selection unit 163 determines that the selection probability is not updated.

(S27) The communication method selection unit 163 updates the selection probability of each communication method in the selection probability table 161a for the transmission data size. The communication method selection unit 163 updates the selection probability in such a manner that the selection probability of each communication method is higher than 0. This is because, when the selection probability of any one of the communication methods is set to 0, the communication method is not selected, and accordingly a change in the average response time for the communication method is not monitored. A method of updating the selection probability is described in detail below.

In the procedure in FIG. 11, whether or not the selection probability is updated is determined at a timing when the transmission of certain transmission data is finished. However, a timing at which whether or not the selection probability is updated is determined may be a timing other than the timing when the transmission of certain transmission data is finished. For example, the communication method selection unit 163 may periodically determine whether or not to update the selection probability with a predetermined interval (for example, with a period of several minutes, several hours, or the like) to update the selection probability. Alternatively, when the communication is performed by selecting the communication method of which the selection probability is low, the communication method selection unit 163 may determine whether or not to update the selection probability after the average response time is updated, and may update the selection probability in response to the determination. This may reduce a frequency of determination of whether or not to update the selection probability.

Next, a processing procedure by the iSER target 270 of the node 200 is described.

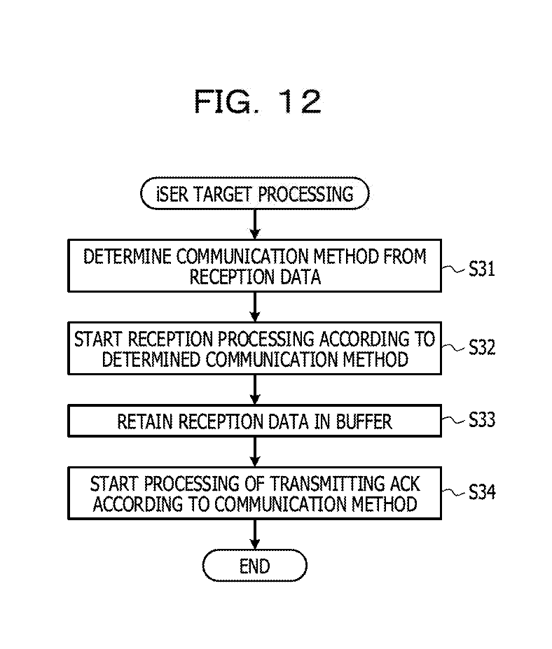

FIG. 12 is a flowchart illustrating exemplary iSER target processing. Processing illustrated in FIG. 12 is described according to a sequential processing number.

(S31) The communication processing unit 272 determines the communication method from the data (the reception data) that is received from the node 100. For example, the communication processing unit 272 determines which one of the communication method A or the communication method B has been used for the current communication.

(S32) The communication processing unit 272 starts the reception processing according to the determined communication method.

(S33) The communication processing unit 272 retains the reception data in the buffer 271. For example, as described above, the communication processing unit 272 stores the reception data in the reception buffer 271a secured in the buffer 271.

(S34) The communication processing unit 272 starts processing of transmitting the ACK according to the current communication method. In this way, the node 200 replies to the node 100 with the ACK.

A specific example of the selection probability update of the communication method by the node 100 is described.

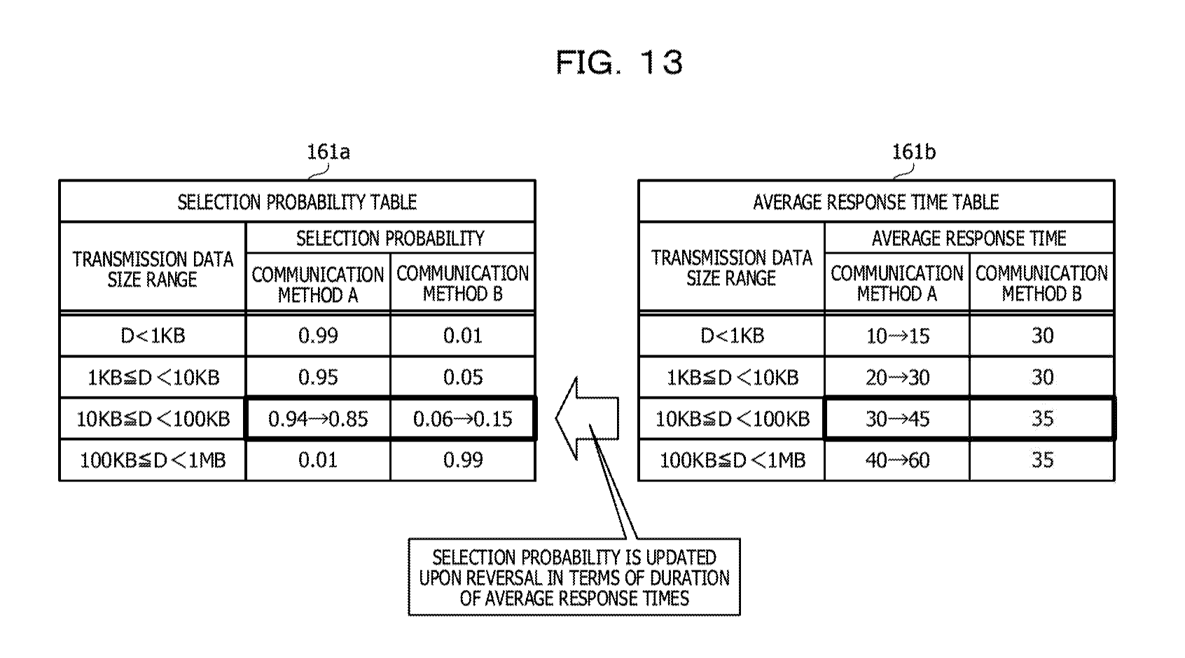

FIG. 13 is a diagram illustrating the specific example (a first specific example) of the selection probability update. In FIG. 13, the symbol “->” indicates the update of a numerical value on the left side of the symbol with a numerical value on the right side of the symbol. In an exemplary average response time table 161b in FIG. 13, as a result of performing the transmission of the transmission data using the communication method A, the average response time for the communication method A is changed as follows at a certain timing.

In the transmission data size range of D<1 KB, the average response time for the communication method A changes from 10 microseconds to 15 microseconds. In the range described above, the average response time for the communication method B is 30 microseconds. Accordingly, in the transmission data size range of D<1 KB, the relationship between the average response times of the communication method A and the communication method B in terms of duration is not reversed.

In the transmission data size range of 1 KB≦D<10 KB, the average response time for the communication method A changes from 20 microseconds to 30 microseconds. In the range described above, the average response time for the communication method B is 30 microseconds. Accordingly, in the transmission data size range of 1 KB≦D<10 KB, the relationship between the average response times of the communication method A and the communication method B in terms of duration is not reversed.

In the transmission data size range of 10 KB≦D<100 KB, the average response time for the communication method A changes from 30 microseconds to 45 microseconds. In the range described above, the average response time for the communication method B is 35 microseconds. That is, in the transmission data size range of 10 KB≦D<100 KB, the relationship between the average response times of the communication method A and the communication method B in terms of duration is reversed.

In the transmission data size range of 100 KB≦D<1 MB, the average response time for the communication method A changes from 40 microseconds to 60 microseconds. In the range described above, the average response time for the communication method B is 35 microseconds. Accordingly, in the transmission data size range of 100 KB D≦1 MB, the relationship between the average response times of the communication method A and the communication method B in terms of duration is not reversed.

In this case, in the transmission data size range of 10 KB≦D<100 KB, the reversal of the relationship between the average response times in terms of duration causes the communication method selection unit 163 to update the selection probability of the communication method A and the selection probability of the communication method B, which are recorded in the selection probability table 161a. For example, in the transmission data size range of 10 KB≦D<100 KB, there is a likelihood that the communication method B may be more advantageous than the communication method A. Accordingly, the communication method selection unit 163 decreases the selection probability of the communication method A and increases the selection probability of the communication method B. An amount by which the selection probability of the communication method A is increased, and an amount by which the selection probability of the communication method B is decreased are desirably given. For example, a maximum value and a minimum value of the selection probability that are given to the communication methods A and B are determined in advance for each transmission size range. The maximum value and the minimum value are values that are greater than 0 and are smaller than 1. It is considered that a change is made such that the selection probability of one communication method (the communication method of which the average response time is short) takes the maximum value and the selection probability of the other communication method (the communication method of which the average response time is long) takes the minimum value.

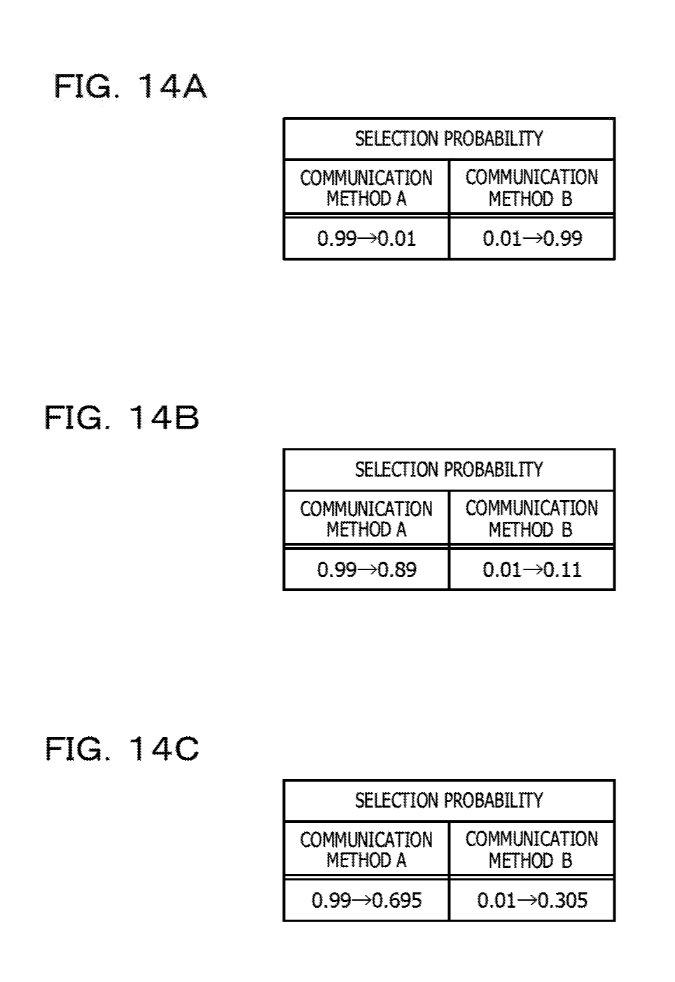

FIGS. 14A, 14B, and 14C are diagrams illustrating a specific example (a second specific example) of the selection probability update. FIG. 14A illustrates a first example of the selection probability update. For example, a case is considered where, in a certain transmission data size, the maximum value of the selection probability of the communication method is 0.99 and the minimum thereof is 0.01, and where, due to the relationship between the average response times in terms of duration being reversed, the average response time for the communication method A is longer than the average response time for the communication method B. In this case, the communication method selection unit 163 updates the selection probability of 0.99 of the communication method A with the selection probability of 0.01. On the other hand, the communication method selection unit 163 updates the selection probability of 0.01 of the communication method B with the selection probability of 0.99. In this manner, the communication method selection unit 163 may greatly increase or decrease the selection probabilities of both of the communication methods by performing the update one time.

FIG. 14B illustrates a second example of the selection probability update. The communication method selection unit 163 may decrease the selection probability of the communication method A from 0.99 to 0.01 and increase the selection probability of the communication method B from 0.01 to 0.99 by a fixed amount of change at a certain rate at a time. FIG. 14B illustrates an example (after the update in the first stage) in which the selection probability is increased by 0.1 at a time and the selection probability is decreased by 0.1 at a time. In this case, the communication method selection unit 163 causes the selection probability to be gradually increased by 0.1 at a time with a certain periodicity (an amount of increase or decrease in the final stage is exceptionally 0.08). Therefore, a fixed period of time (which is referred to as an update period of time) occurs from when the selection probability update is started to when the selection probability update is ended. In an update period of time, in a case where the relationship between the average response times of the communication method A and the communication method B in terms of duration is again reversed (in a case where the relationship between the average response times returns to its original state) in terms of duration, the communication method selection unit 163 stops the update of the selection probability of the communication method A and the selection probability of the communication method B. Then, the communication method selection unit 163 returns both of the selection probabilities to values that are present before the update period of time. In a case where the selection probability is returned, in the present example, the communication method selection unit 163 returns the selection probability of the communication method A to 0.99 and the selection probability of the communication method B to 0.01. In this manner, the selection probability is gradually updated, and thus a change in the performance characteristic due to a temporary factor may be suitably dealt with.

FIG. 14C illustrates a third example of the selection probability update. The communication method selection unit 163 may determine an amount Δp of change when the selection probability is gradually increased or decreased, according to a difference between both of the selection probabilities. For example, the communication method selection unit 163 may obtain a difference d between the selection probability of the communication method A and the selection probability of the communication method B, and may obtain an amount of change according to the difference d. For example, the communication method selection unit 163 determines that the amount Δp of change is d/4+0.05.

In the example described above, it is assumed that the selection probability of or the average response time for each communication method is managed with respect to the transmission data size (the size of the transmission data stored in the buffer 162). On the other hand, the communication method selection unit 163 may manage the selection probability of or the average response time for each communication method for the communication packet size. That is, the communication packet is considered to be an example of the communication data, or the communication packet size is considered to be an example of the communication data size.

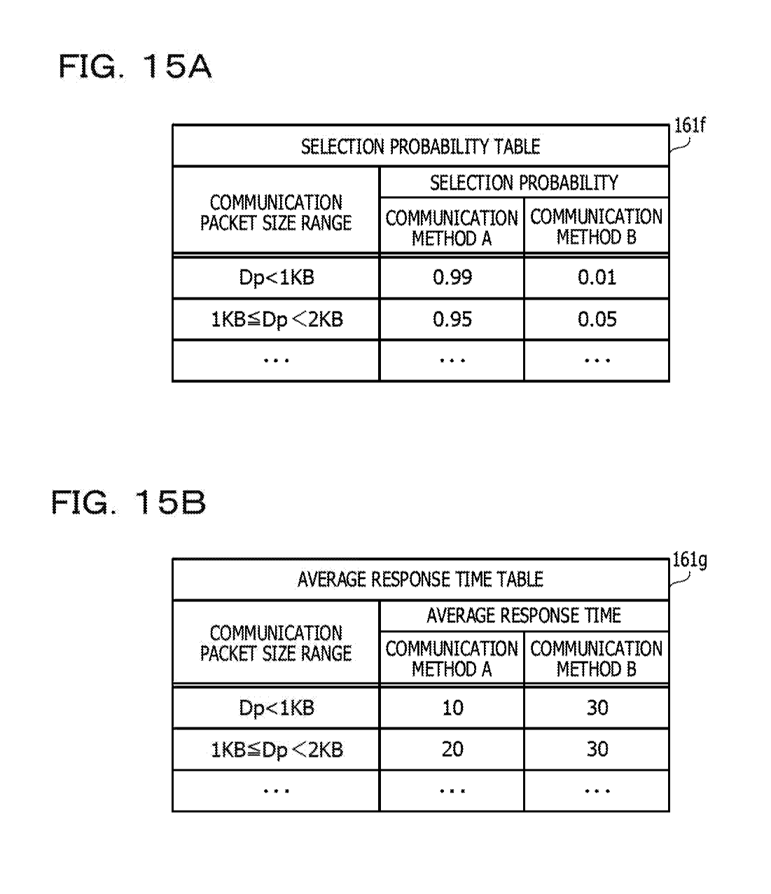

FIGS. 15A and 15B are diagrams illustrating an exemplary table for the communication packet size. FIG. 15A illustrates a selection probability table 161f. FIG. 15B illustrates an average response time table 161g. The selection probability table 161f is different from the selection probability table 161a in that the selection probability of the communication method A and the selection probability of the communication method B are registered for a communication packet size range. The average response time table 161g is different from the average response time table 161b in that the average response time for the communication method A and the average response time for the communication method B are registered for the communication packet size range.

For example, ranges (communication packet size ranges) of the communication packet sizes Dp are categorized in such a manner that Dp<1 KB, 1 KB≦Dp<2 KB, and so forth. The selection probability of the communication method A and the selection probability of the communication method B are registered in the selection probability table 161f, for each communication packet size range. The average response time for the communication method A and the average response time for the communication method B are registered in the average response time table 161g, for the communication packet size range.

Based on the selection probability table 161f, the communication method selection unit 163 acquires the selection probability of the communication method A and the selection probability of the communication method B, for the current communication packet size. The communication method selection unit 163 may also select any one of the communication methods A and B in response to both of the selection probabilities. The communication method selection unit 163 records, for the communication for the communication packet size, the average response time for the communication that uses the selected communication method, in the average response time table 161g. Then, the communication method selection unit 163 may update the selection probability of the communication method A and the selection probability of the communication method B in accordance with the reversal of the relationship between the average response times of the communication method A and the communication method B in terms of duration in the average response time table 161g.

In the above description, the case including two communication methods as selection candidates is described as an example, but three or more communication methods may be employed as the selection candidates. When there are three or more communication methods as the selection candidates, for example, in a case where an average response time for a first communication method is longer than an average response time for a second communication method, the communication method selection unit 163 decreases a selection probability of the first communication method and increases a selection probability of the second communication method. In a case where the average response time for the first communication method is longer than average response times for a plurality of second communication methods, the communication method selection unit 163 may decrease the selection probability of the first communication method and increase selection probabilities of the plurality of second communication methods.

For example, in a case where there are a plurality of selection candidates for the communication method, the communication performance in accordance with the communication data size (the transmission data size or the communication packet size within the transmission buffer) may be measured in advance for each communication method, at the time of development of an apparatus, or the like. A condition (a static condition) in which the communication methods to be selected are determined for each communication data size is stored in advance in the nodes 100 and 200.

However, if the communication method is determined in such static condition, as is illustrated in FIG. 6, the determination of the communication method is fixed by the condition. Accordingly, there may be a problem in that a change in a status (for example, a change in the communication performance due to a change in the load on the nodes 100 and 200 or the like) is difficult to deal with.

On the other hand, with the node 100, the communication method is selected according to the selection probability, and the selection probability is updated based on the result of the communication. At this time, for a certain communication data size, the selection probability of the communication method that may realize relatively high communication performance is set to be relatively high, and the selection probability of the communication method in which the communication performance is relative low is set to be relatively low. Thus, it is possible that, while comparatively high communication performance is realized, a change in the performance characteristic is grasped with the comparison between the communication performances of the communication methods. In this way, the node 100 may determine a suitable communication method in response to the change in the status.

The information processing according to the first embodiment may be realized by causing the arithmetic operation unit 1b to execute a program. The information processing according to the second embodiment may be realized by causing the processor 101 to execute a program. Such programs may be recorded in the computer-readable recording medium 13.

For example, programs may be circulated by distributing the recording media 13 on which a program is recorded. A program may be stored in another computer and the program may be distributed over a network. A computer, for example, may store (install) the program recorded on the recording medium 13 or the program received from another computer in the storage device such as the RAM 102 or the HDD 103 and may read and execute the program from the storage device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for determining a communication method executed by a processor included in a computer, the method comprising:
selecting a communication method from a plurality of communication methods based on a size of communication data, by referring to selection probability information in which a range of a size of communication data and a probability of selecting a communication method are associated for each of the plurality of communication methods;
executing communication using the selected communication method;
updating the selection probability information based on a result of the executed communication; and
executing communication based on the updated selection probability information.

2. The method for determining a communication method according to claim 1,
wherein the updating includes updating a first selection probability of a first communication method and a second selection probability of a second communication method in accordance with comparison between a first average response time indicating an average value of a response time for the first communication method and a second average response time indicating an average value of a response time for the second communication method.

3. The method for determining a communication method according to claim 2,
wherein the updating includes decreasing the first selection probability and increasing the second selection probability when the first average response time is longer than the second average response time.

4. The method for determining a communication method according to claim 2,
wherein the updating includes updating the first selection probability and the second selection probability in stages by a predetermined amount of change at a time.

5. The method for determining a communication method according to claim 4,
wherein the updating includes determining the amount of change in accordance with a difference between the first selection probability and the second selection probability.

6. The method for determining a communication method according to claim 2,
wherein the updating includes causing a relationship between the first selection probability and the second selection probability to be reversed in terms of selection frequency, when a relationship between the first average response time and the second average response time is reversed in terms of duration.

7. The method for determining a communication method according to claim 1,
wherein the size of communication data is a communication packet size.

8. The method for determining a communication method according to claim 2,
wherein each of the first average response time and the second average response time is measured by obtaining an interval between a point in time when a communication packet is transmitted and a point in time when an acknowledgement (ACK) of the communication packet, which is transmitted from a computer that is a communication destination is received.

9. An information processing apparatus comprising:
a memory; and
a processor coupled to the memory and configured to:
select a communication method from a plurality of communication methods based on a size of communication data, by referring to selection probability information in which a range of a size of communication data and a probability of selecting a communication method are associated for each of the plurality of communication methods;
execute communication using the selected communication method;
update the selection probability information based on a result of the executed communication; and
execute communication based on the updated selection probability information.

10. A non-transitory computer-readable recording medium storing a program that causes a processor included in an information processing apparatus to execute a process, the process comprising:
selecting a communication method from a plurality of communication methods based on a size of communication data, by referring to selection probability information in which a range of a size of communication data and a probability of selecting a communication method are associated for each of the plurality of communication methods;
executing communication using the selected communication method;
updating the selection probability information based on a result of the executed communication; and
executing communication based on the updated selection probability information.
